(19) United States
(12) Patent Application Publication
(10) Pub. No.: US 2026/0019122 A1
(43) Pub. Date: Jan. 15, 2026

(54) METHOD AND APPARATUS FOR DATA-DRIVEN COMPRESSION OF MIMO PRECODING FEEDBACK

(71) Applicant: INTERDIGITAL PATENT HOLDINGS, INC., Wilmington, DE (US)

(72) Inventors: Satyanarayana Katla, London (GB); Arman Shojaeifard, London (GB); Javier Lorca Hernando, Madrid (ES)

(73) Assignee: INTERDIGITAL PATENT HOLDINGS, INC., Wilmington, DE (US)

(21) Appl. No.: 18/992,778

(22) PCT Filed: Jul. 11, 2023
(86) PCT No.: PCT/US2023/027367

§ 371 Date: Jan. 9, 2025

Related U.S. Application Data
(60) Provisional application No. 63/388,132, filed on Jul. 11, 2022.

(51) Int. Cl. H04B 7/06; H04B 7/0417

(52) U.S. Cl. CPC H04B 7/0626; H04B 7/0417; H04B 7/0658

(57) ABSTRACT

Methods for data-driven multiple input-multiple output (MIMO) precoder compression are described herein. A method may include receiving one or more channel state information (CSI) reference signals (RSs) using a plurality of subbands. The method includes transmitting a report indicating coherence time information associated respectively with the plurality of subbands, wherein the coherence time information associated respectively with the plurality of subbands is determined based on CSI determined from the received CSI-RSs. The method includes receiving at least one second CSI-RS using the at least one of the plurality of subbands. The method includes transmitting feedback to the transmitter including compressed information indicating, for the at least one of the plurality of subbands, suggested precoding parameters determined based on the received at least one second CSI-RS, wherein the feedback is transmitted within a coherence time associated with the at least one of the plurality of subbands.

### CROSS-REFERENCE TO RELATED APPLICATIONS

This application claims the benefit of U.S. Provisional Application No. 63/388,132 filed Jul. 11, 2022, the contents of which are incorporated herein by reference

### BACKGROUND

Employing channel adaptive signaling in wireless communication systems may yield large improvements in almost any performance metric. These adaptive techniques may require channel knowledge at the transmitter. Unfortunately, this cannot be leveraged directly in frequency division duplexing systems. However, having the receiver feedback a few bits about the channel conditions such as channel quality, rank, etc., can allow near-optimal adaptation. This type of channel information sent by the receiver to the transmitter is typically referred to as limited or finite-rate feedback. With carefully designed feedback, the otherwise unrealizable perfect transmitter channel knowledge can be realized with near-optimal performance.

### SUMMARY

Methods for data-driven multiple input-multiple output (MIMO) precoder compression are described herein. A method may include receiving one or more channel state information (CSI) reference signals (RSs) using a plurality of subbands. The method includes transmitting a report indicating coherence time information associated respectively with the plurality of subbands, wherein the coherence time information associated respectively with the plurality of subbands is determined based on CSI determined from the received CSI-RSs. The method includes receiving at least one second CSI-RS using the at least one of the plurality of subbands. The method includes transmitting feedback to the transmitter including compressed information indicating, for the at least one of the plurality of subbands, suggested precoding parameters determined based on the received at least one second CSI-RS, wherein the feedback is transmitted within a coherence time associated with the at least one of the plurality of subbands.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration of MIMO system according to at least one embodiment described herein;

FIG. 3 is a flowchart illustrating steps for online training/retraining as may be performed by a transmitter in a MIMO system;

FIG. 4 is a flowchart illustrating steps for online training/retraining as may be performed by a receiver in a MIMO system

FIG. 5 illustrates an example of a compression ratio index look-up table;

FIG. 6 is a signaling flow chart depicting an example of signaling as may be performed between a transmitter and a receiver for online training or retraining;

FIG. 7 is a flowchart illustrating steps for real-time link adaptation as may be performed by a transmitter in a MIMO system;

FIG. 8 is a flowchart illustrating steps for real-time link adaptation as may be performed by a receiver in a MIMO system

FIG. 9 is a schematic illustrating an example of the signaling between a transmitter and a receiver performing real-time link adaptation.

### DETAILED DESCRIPTION

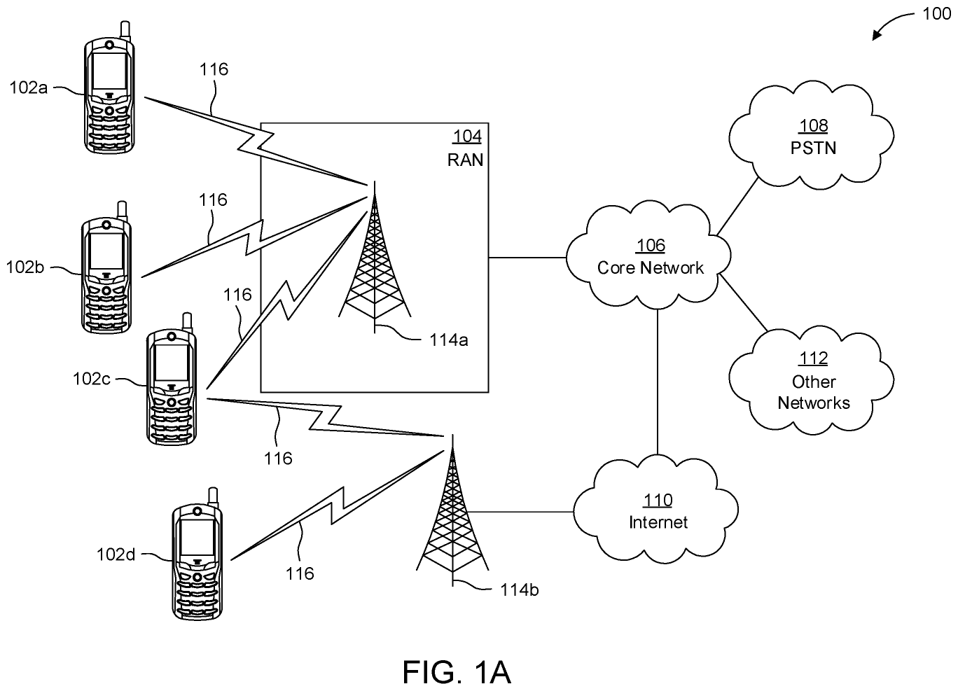

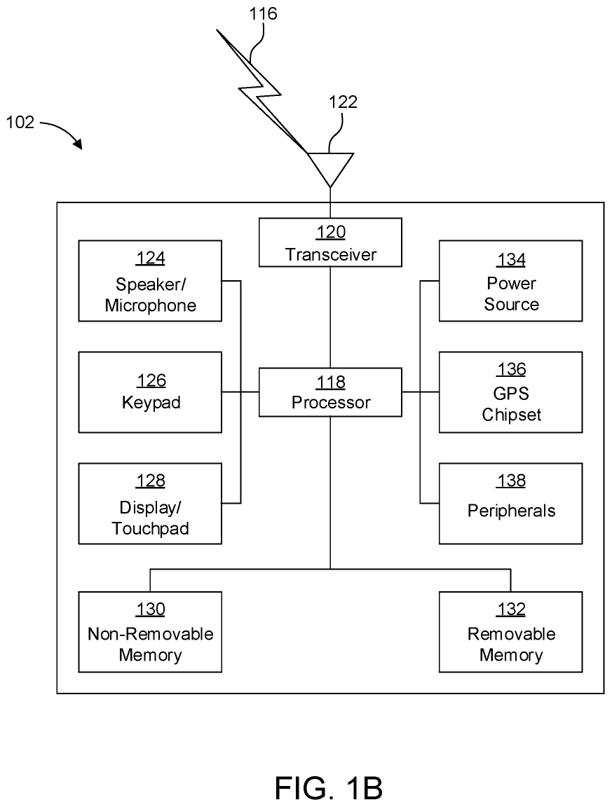

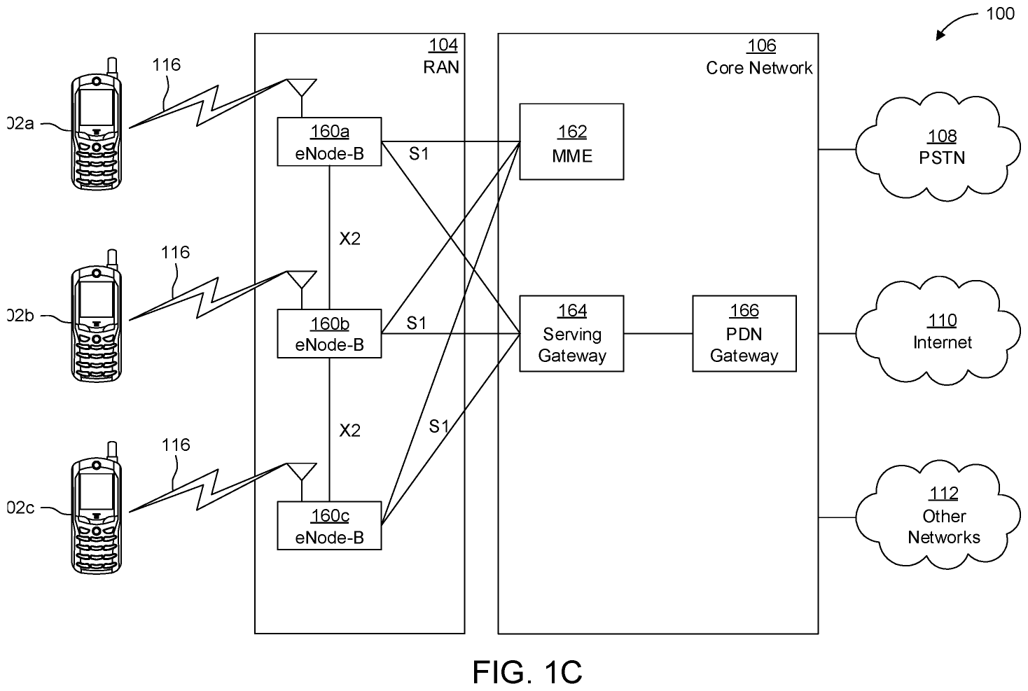

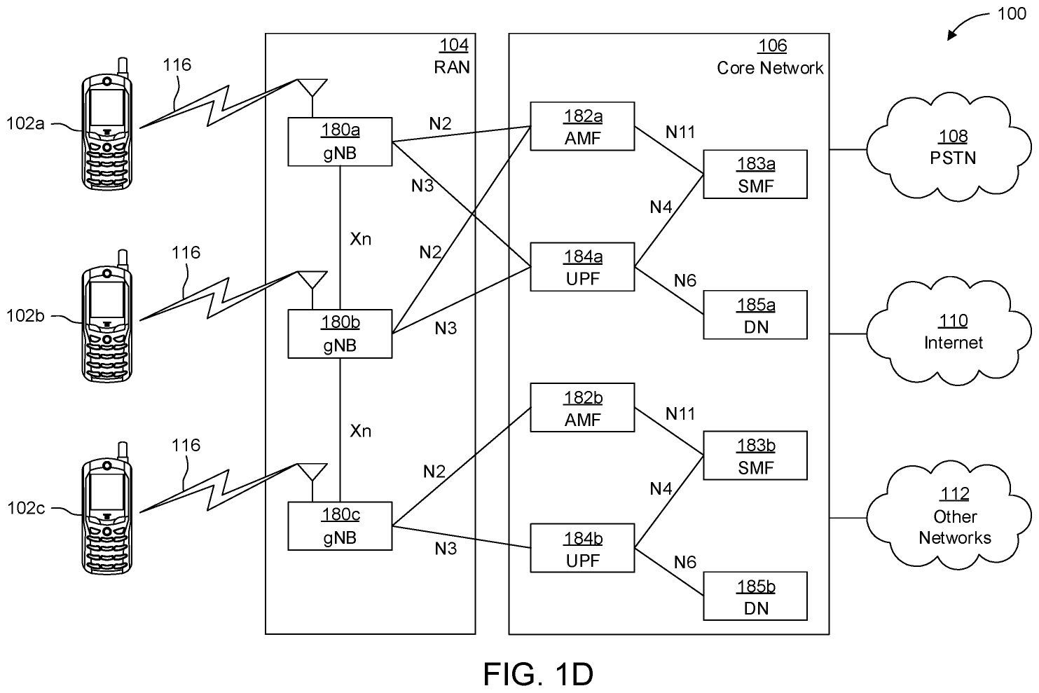

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

MIMO precoding is a technique used in wireless communication systems to improve the performance and capacity of the system. MIMO systems may realize increased diversity by processing transmit signals at the transmitter before transmitting them through multiple antennas, exploiting the spatial dimension and multiplexing gain to achieve higher data rates and better reliability. A common approach to realize these benefits is to use multiple transmit antennas and/or multiple receive antennas. In traditional MIMO precoding schemes, each transmit antenna may require a separate radio frequency (RF) chain, including a digital-to-analog converter (DAC), analog components, and a power amplifier. This may lead to increased hardware complexity, power consumption, and cost. The analog components in the RF chains may be controlled based on precoding weights calculated in a digital baseband processing stage. The precoding weights may serve to optimize the transmission based on available channel information, and may, for example, maximize signal power, minimize interference, or balance multiple objectives. During the precoding stage, the transmit signals may be optimized based on channel conditions. Some MIMO systems may utilize hybrid precoding, which combines analog and digital precoding. In hybrid precoding, the transmit signal is divided into two stages: analog precoding performed in the RF domain and digital precoding performed in the baseband domain. This approach may significantly reduce the number of RF chains required while still achieving most of the performance benefits of MIMO.

Feedback information may be used by the transmitter to determine precoding parameters, such as the precoding or beamforming weights. A receiver in a MIMO system may provide limited feedback about the channel conditions by way of channel state information (CSI), which may include a channel quality indicator (CQI), rank indicator (RI) of the channel, precoder matrix indicator (PMI), interference level, received power, or other information. The type of information fed-back by the receiver may depend on network requirements. The value of the transmitted feedback may vary based on the system scenario. The feedback may constitute parameters that the receiver believes, based on its observations of the channel conditions, are suitable to use for multi-antenna precoding. It should be understood that, while the transmitter may utilize the receiver's feedback to determine actual precoding parameters, the feedback may not impose restrictions upon the precoding matrix that the transmitter subsequently uses. For example, the transmitter may base its decision upon feedback received from another device (or multiple other devices) that favors other precoding parameters.

The receiver may determine such feedback through channel estimation, in which the receiver receives reference signals (e.g., CSI-RS) from the transmitter using configured or known resources. These signals are transmitted through the antennas and are designed to enable the receiver to estimate the channel response for each transmit-receive antenna pair. Based on the channel estimates, the receiver may construct a channel matrix, which may be referred to as the channel matrix or the channel response matrix. This matrix may represent the channel gains and phase shifts for each antenna pair. To reduce the feedback overhead, the receiver may quantize the estimated channel matrix by mapping continuous values from the channel matrix to discrete values that can be efficiently transmitted back to the transmitter. The quantized CSI is may be represented by a finite number of bits or symbols.

The feedback may be conveyed through various means, such as dedicated control channels, uplink transmissions, or dedicated feedback channels. For example, a receiver that transmits feedback may use a low rate data stream on the reverse side of the link to convey the information of the channel to the transmitter of the forward side of the link. In such case, feedback information associated with the downlink carrier frequency channel may be conveyed by the receiver on the uplink carrier frequency.

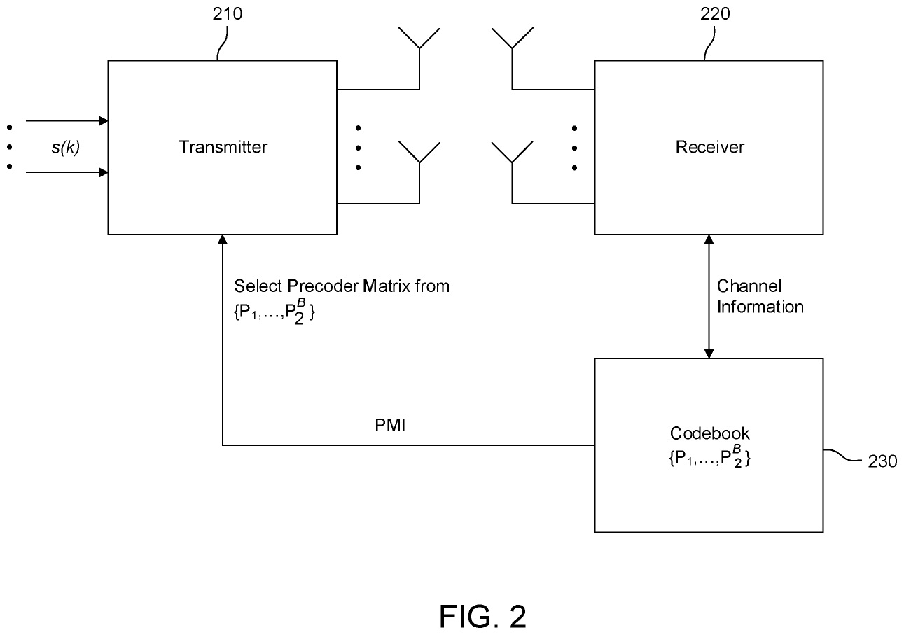

FIG. 2 is an illustration of MIMO system according to at least one embodiment described herein. FIG. 2 illustrates the sending of channel information feedback from a receiver 220 to a transmitter 210. Receiver 220 may be a WTRU though in some embodiments, the receiver may be a UE, a base station (BS), a nodeB, a transmit receive point (TRP), a remote radio head (RRH), a STA, an AP, or any multi-antenna device. In a similar vein, the transmitter 210 may be a WTRU, a UE, a base station (BS), a nodeB, a transmit receive point (TRP), a remote radio head (RRH), a STA, an AP, or any multi-antenna device. In some embodiments consistent with the illustration of FIG. 2, the transmitter 210 may be configured to send transmissions to the receiver 220 using multiple antennas. The transmissions may include data associated with one or more data streams, s(k).

The receiver 220 may derive knowledge of the downlink channel using one or more reference symbols transmitted by the transmitter 210. The receiver 220, upon estimating the channel, may select a precoder from a codebook 230, which may be known to both the receiver 220 and the transmitter 210. The codebook 230 may include a set of precoders {P₁, . . . , P₂^{B}}, each of which may be tailored/designed according to a specific channel distribution that is assumed. The codebook has a size 2^{B}. Parameters associated with the selected precoder may correspond to channel eigen values, phase quantization values, or quantized channel matrices, for example. The selection of a precoder from the codebook 230 is demonstrated in FIG. 2, as the receiver 220 transmits a signal providing an indication of precoding parameters that correspond to the selected precoder. As shown in FIG. 2, the receiver 220 may send a message to the transmitter 210 including feedback information. The feedback information may include, for example, a precoding matrix indicator (PMI) which may be an index that corresponds to the selected precoder from the codebook 230. The parameter B may be a number of bits used to convey the index.

The receiver 220, through this feedback, may provide the transmitter 210 with information to infer how the signal may be best adapted according to the status of the channel. As shown in FIG. 2, the transmitter 210 may, for example, select a precoding matrix from the codebook based on the PMI sent by the receiver 220.

The number of feedback bits required to convey the channel information may depend on the codebook size. For a codebook of size 2^{B}, the receiver 220 may indicate B bits of the selected precoder may be sent over the feedback channel. It should be noted that the rate and/or signal-to-noise ratio (SNR) may be useful information to facilitate communication and may also be fed back.

Having discussed the codebook-based feedback by the receiver, it is also important to note that the channel state information conveyed in feedback from the receiver 220 may be outdated or may suffer from feedback errors (e.g., due to hardware impairments). Because of these errors, the transmitter 210 may need to adapt transmit power and/or data rate due to imperfect channel state information at the transmitter (CSIT). In order to effectively exploit the imperfect CSIT, it may be important to account for error statistics of the CSIT in link adaptation. However, it may be difficult for the transmitter to obtain and keep track of the error statistics because they may depend on the channel environment and Doppler spectrum. In such cases, ACK/NAK signaling from the upper layer ARQ can be useful for enabling a closed-loop adaptation.

Additionally, in understanding the benefits of finite rate feedback, it may also important to recognize drawbacks. Using feedback to increase the achievable data rate on one side of a link may request increased overhead on the other. In practice, the amount of overhead required in providing feedback may be non-negligible. For example, in 5G NR systems, the overhead involved in high-resolution feedback for multiuser scenarios may be on the order of several hundreds of bits. This may significantly reduce the throughput of the system.

Embodiments described herein may address a variety of technical shortcomings and challenges in the state-of-the-art precoding/codebook design for MIMO systems in the face of time-varying channel conditions. Among such technical challenges, the selection of the precoding parameters (e.g., PMI, RI, etc.) based on channel estimates performed by the receiver may be inaccurate for at least the following reasons, as expressed briefly in paragraphs above. Hardware imperfections arising due to non-linear components may distort the channel estimates. The delay arising in the feedback sent by the receiver to the transmitter due to channel aging may render the indicated PMI that is received by the transmitter outdated. A codebook-based precoder, which may be determined based on a fixed probability distribution to represent the wireless channel, (e.g., based on urban, rural, or other environments/) may further result in high quantization error. On the other hand, transmission of a non-codebook based precoder, which may capture the CSI more accurately, may significantly increase the overhead in FDD systems. Therefore, to improve performance while also reducing the feedback overhead, precoder compression and feedback techniques that capture both CSI as well as hardware nonlinear properties may be required.

Various solutions to the above-described challenges are proposed herein. In the following paragraphs, methods for data-driven MIMO precoder compression and feedback to improve the quality-of-service (e.g. BER, rate) as well as to reduce the feedback overhead based on the observed data are described. Some proposed techniques may allow the receiver to signal a compressed precoder, and some proposed feedback techniques may allow the transmitter to decompress the precoder in the time-varying channel conditions with low overhead. In the embodiments proposed herein, an “indication of a precoder” may refer to information indicating a set precoding parameter (PMI, RI, CQI, etc.), indices associated with precoding parameters, precoding matrices, a number of transmission layers (i.e., N_{L}) and/or CSI reports that may be used for multi-antenna transmissions. The terms “CSI report,” “indication of a precoder,” “precoder,” and “feedback” may be used interchangeably herein. The term “compressed precoder” may refer to compressed (or encoded) data that provides an indication of precoding parameters.

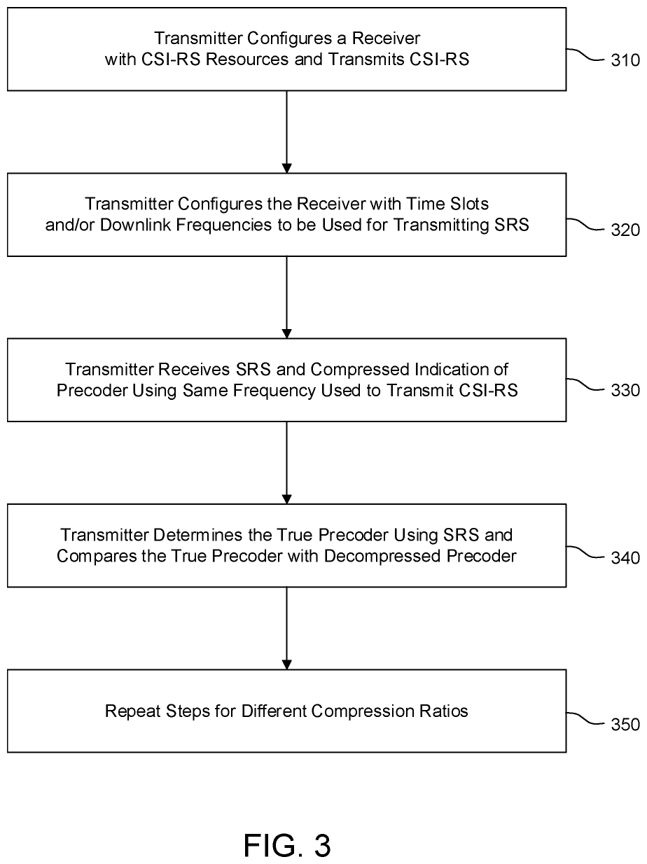

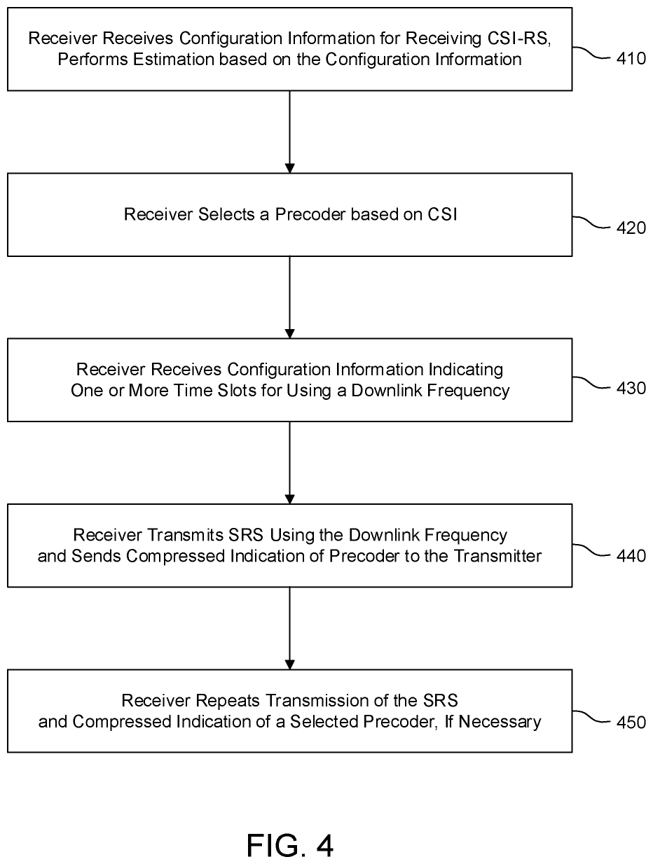

FIGS. 3 and 4 are flowcharts illustrating steps as may be performed when employing data-driven precoder compression techniques. Data-driven MIMO precoder compression may be implemented by exploiting channel estimates performed by the receiver. This may be achieved by designing a functional mapping between channel estimates and the precoder selection using data-driven approaches involving, i.e., machine learning, autoencoders, etc. In contrast to state-of-the-art precoding techniques, these techniques may involve determining a precoder that adapts to the CSI observed at the transmitter during data transmission. In other words, in real time, the receiver may send feedback to the transmitter including a compressed indication of the precoding parameters, where the precoding parameters are based on channel estimates observed over a period of time. The transmitter may decompress the compressed indication of the precoding parameters fed-back by the receiver by, for example, using a decoder counterpart of the encoder employed at the receiver. As will be explained in further detail herein, the decompression of the compressed indication of the precoding parameters may be subject to error. For example, errors in the compression or decompression may result in discrepancies between the proposed precoding parameters that the receiver determines for the channel and the decompressed parameters that the transmitter derives from the compressed information received from the receiver. The degree of error experienced may vary based on, for example, the compression ratio utilized by the receiver to compress the suggested precoding parameters. As such, an adaptation of the compression ratio for the precoder may be provided depending on the BER/rate requirements. Such a method may provide better performance in terms of BER/rate as well as provide low overhead for precoder feedback.

Some embodiments may provide for online training/retraining. Online training/retraining may refer to data-driven precoder compression techniques where the functional mapping between the uncompressed precoding parameters and the compressed symbols that are used to convey the precoding parameters is developed using computational resources at the network (e.g., by the transmitter in a MIMO system, by a base station, by a nodeB, or by another network node). A more detailed step-by-step procedure according to at least one embodiment is presented in the following paragraphs. In the model described, one or more assumptions relating to the setup and other key aspects may be necessary. For example, it may be assumed that the transmitter is implemented with a decoder (e.g. an AI model-based autoencoder-decoder) for decompression of the compressed precoder, while the receiver may be implemented with an encoder (e.g. AI model-based autoencoder or transfer learning-based AI models) for compressing the precoder. The initial weights of the encoder and decoder may be determined as follows. For online training, the initial weights may be randomly assigned. For retraining, the initial weights may be pre-determined. For example, the initial weights may be computed via offline training and stored in a database.

FIG. 3 is a flowchart illustrating steps for online training/retraining as may be performed by a transmitter in a MIMO system. As shown at 310, a transmitter may configure a receiver with resources (i.e., time and frequency domain resources) for receiving CSI-RS (additionally, or alternatively, with resources for receiving a downlink reference signal) and may transmit CSI-RS. A receiver that is configured to receive the CSI-RS may perform channel estimation on the configured CSI-RS resources to determine CSI. The receiver may determine the downlink transmit precoder (i.e., a set of suitable precoding parameters that may be used by the transmitter to transmit downlink signals). To reduce overhead when sending feedback to the transmitter, the receiver may employ a precoder compression encoder (e.g., using an AI model) and request an uplink grant in the downlink frequency.

In some embodiments, as shown at 320, the transmitter may configure the receiver with one or more time slots for sending signals in the uplink using one or more of the downlink frequencies in which the transmitter transmitted CSI-RS and for which the receiver is to estimate CSI and determine a downlink transmit precoder. This may enable training of both a decoder at the transmitter and an encoder at the receiver.

For example, as shown at 330, the transmitter may receive reference signals (e.g., sounding reference signals) based on the downlink frequencies and time slots indicated to the receiver. The transmitter may also receive a compressed indication of the precoder determined by the receiver from the earlier-transmitted CSI-RS. The transmitter may decode the receiver's compressed indication of the precoder to decompress the compressed indication of the precoder. The transmitter may perform channel estimation of the reference signals to determine the true precoder for the downlink frequency. As shown at 340, the transmitter may compare the true precoder with the decompressed precoder for the same downlink frequency. The transmitter may employ different metrics (e.g. a normalized mean squared error (I2 norm), chordal distance, or other metrics) to measure the loss between the decompressed precoder and the true precoder. This may enable the transmitter to compute the error between the decompressed precoder and the true precoder for training the model (e.g., a deep neural network (DNN) or another type of AI/ML model) used to predict precoding weights to be used by the decoder and/or encoder.

In some cases, such as in frequency division duplexing (FDD) systems (or, for systems in which switching may not be feasible), the transmitter may request that the receiver transmit explicit information indicating true precoder weights using physical uplink control channel (PUCCH) and/or physical uplink shared channel (PUSCH) transmissions or using other logically equivalent channels or messages. For example, the explicit information indicating true precoder weights may comprise an uncompressed indication of the precoder weights.

In some embodiments, as shown at 350, the process may be repeated for different compression ratios, which may enable online training/retraining. For example, during training, the transmitter-receiver pair may continue the process of configuring CSI-RS, time slots for switching to a downlink frequency, receiving sounding reference signals (SRSs), etc., until the training model converges or until the observed error measured using a loss function (e.g. normalized mean squared error (I2 norm), chordal distance)) reaches a minimum level. To achieve this, the following cases may be considered. In some options, different DNN (or AI/ML model) weights for different compression ratios may be designed. In some options, a unified DNN (or AI/ML model) model for different compression ratios may be designed.

FIG. 4 is a flowchart illustrating steps for online training/retraining as may be performed by a receiver in a MIMO system. As shown at 410, the receiver receives configuration information for receiving CSI-RS. The receiver may perform channel estimation based on the configuration information to determine CSI. As shown at 420, the receiver may determine a suitable downlink transmit precoder. To reduce overhead when sending feedback to the transmitter, the WTRU may employ a precoder compression encoder (e.g., using an AI model) and request an uplink grant in a downlink frequency (or frequencies) for which CSI was determined.

At 430, the receiver receives configuration information indicating one or more time slots in which the receiver may transmit using the downlink frequency (or frequencies). The received configuration information may indicate the downlink frequency to be used by the receiver. The downlink frequency may be a frequency for which the receiver determined CSI. The receiver may switch to a downlink frequency during the indicated time slots. At 440, the receiver may, using the configured time slots and downlink frequency, switch to the downlink frequency and transmit reference signals (e.g., SRS) for estimation by the transmitter. The receiver may also send a compressed indication of the precoder (e.g., via a PUSCH transmission or a transmission using another logically equivalent channel). At 450, the receiver may repeat one or more of the previous steps (e.g., for different compression ratios).

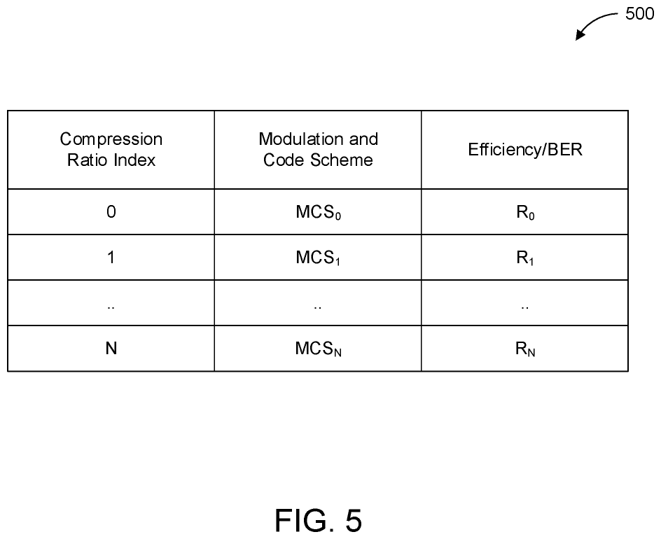

FIG. 5 illustrates an example of a compression ratio index look-up table. The compression ratio index look-up table is a tabular representation of an association between a compression ratio index, a modulation coding scheme (MCS), and an efficiency/BER. It should be appreciated the association between the compression ratio index and the MCS and the association between the compression ratio index and a efficiency/BER may be optional features that a model (i.e., a DNN or another type of AI/ML model) may determine.

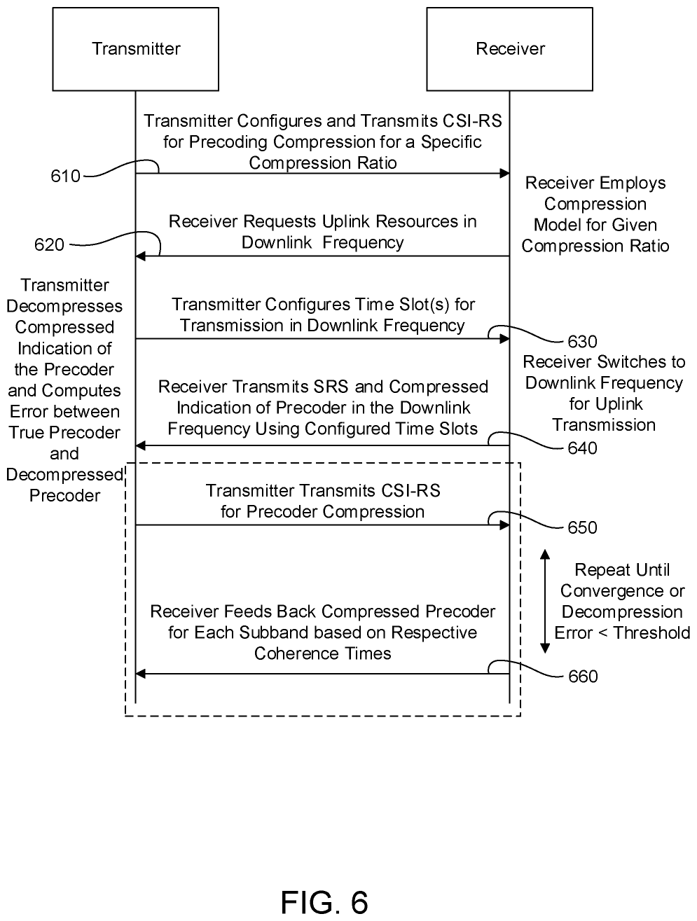

FIG. 6 is a signaling flow chart depicting an example of signaling as may be performed between a transmitter and a receiver for online training or retraining. The example shown in FIG. 6 may be employed similarly for different compression ratios. As shown in FIG. 6, at 610, the transmitter may configure the receiver to receive CSI-RS and, using a downlink frequency, may transmit the CSI-RS. The CSI-RS may be used by the receiver and/or transmitter to train a model for precoding compression at a specific compression ratio. The receiver may measure the CSI-RS and employs a precoder compression model for the specific compression ratio to determine a precoder for the channel. At 620, the receiver may request resources in the downlink frequency to use for an uplink transmission of reference signals. At 630, the transmitter may configure the receiver with one or more time slots to send uplink transmissions in the downlink frequency. The receiver may then switch to the downlink frequency before, at 640, transmitting SRSs and a compressed indication of the determined precoder in the configured time slots. The transmitter may determine a true precoder for the channel based on the received SRS and may decompress (or decode) the compressed indication of the precoder. The transmitter may compute an error between the true precoder and the decompressed decoder. The computed error may be used to train an AI/ML model for precoder compression. At 650, the transmitter again transmits CSI-RS for precoder compression, possibly using a different compression ratio. As is shown in FIG. 6, at least steps 640 and 650 may be repeated until an AI/ML model converges, or until the computed decompression error falls below a threshold value.

Embodiments relating to real-time link adaptation and inference of precoding parameters are described herein. As will be described in greater detail below, the following embodiments may be implemented by participants in a MIMO system including at least one transmitter and at least one receiver. Embodiments described herein may be implemented in conjunction with (or in parallel with) embodiments described above with respect to online training/retraining. Alternatively, embodiments described herein may be implemented independent of those described above with respect to online training/retraining.

In some embodiments as are described in greater detail in paragraphs below, participants in the MIMO system may leverage channel coherence to reduce the amount of overhead in signaling the precoder. Channel coherence may refer to a time-frequency region in which channel conditions remain constant. By the same token, coherence time may represent a time during which the characteristics of the channel (e.g., pathloss, delay, and fading) remain constant, and coherence bandwidth may refer to a range of frequencies for which the aforementioned characteristics remain constant. Channel coherence may fluctuate for example, based on the environment, the mobility of users, and the frequencies in which the users operate. A receiver in a MIMO system may be configured to estimate channel coherence, coherence time, and/or coherence bandwidth by measuring channel characteristics. For example, the receiver may implicitly estimate channel coherence when measuring CSI-RS to determine channel state information. Another method for estimating the change in channel conditions may be to measure Doppler spread, which may be related to a user's velocity and the carrier frequency. Doppler spread may be estimated from changes in the phase or frequency of a received signal over time. An inverse of the maximum Doppler shift (Doppler frequency), for example, may serve as an approximation for the coherence time. Other metrics such as a Received Signal Strength Indicator (RSSI), Reference Signal Received Quality (RSRQ), or Channel Quality Indicator (CQI) may provide insights into how quickly the channel conditions are changing. Similar methods may be used by the transmitter to estimate channel coherence.

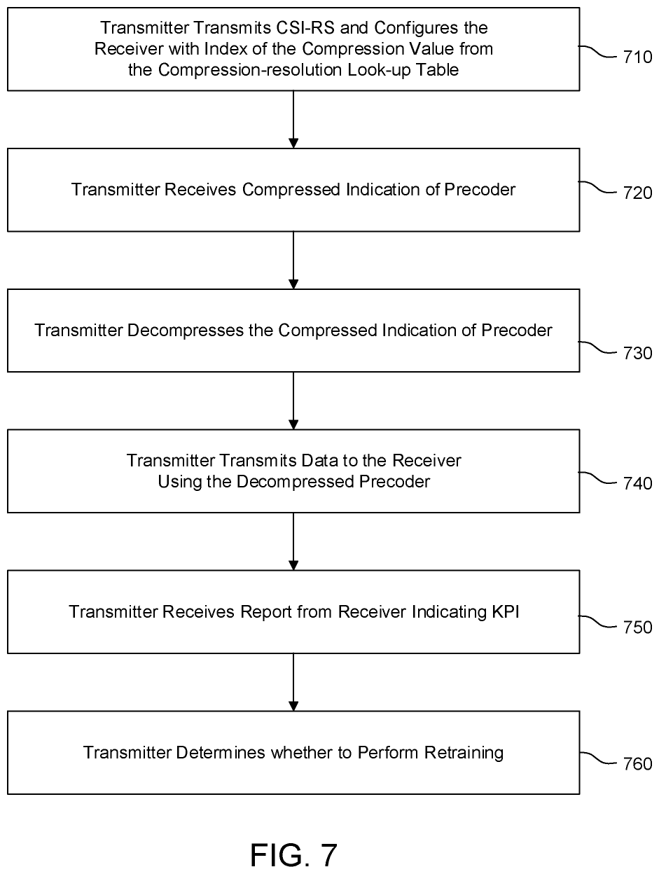

FIG. 7 is a flowchart illustrating steps for real-time data driven precoder compression as may be performed by a transmitter. As shown at 710, the transmitter may transmit CSI-RS to the receiver. The transmitter may, in some embodiments, configure the receiver with a precoder compression index (i.e., corresponding to a specific precoder compression ratio) for each subband, depending on the transmitter's transmission requirements. The precoder compression index may be associated with the precoder compression ratio and/or an MCS, substantially as illustrated by the table of FIG. 5, described above. More explicitly, the transmitter may configure the receiver with a lower compression ratio for high resolution requirements (e.g., for MU-MIMO implementations), while the transmitter may configure the receiver with a higher compression ratio for low resolution requirements, (e.g., for SU-MIMO implementations). Furthermore, in scenarios where the channel is frequency-selective, or where the channel experiences different interference levels for different subcarriers, the transmitter may configure different compression ratios for different subbands. In some embodiments, the transmitter may request that the receiver provide an uncompressed indication of the precoder for uses cases when a highest resolution indication is required.

In some embodiments, such as those where channel coherence is leveraged to reduce precoder signaling overhead, the transmitter may request that the receiver feeds-back its indication of the precoder within a given time frame. The time frame may be specified as a percentage of the coherence time. The transmitter may also receive a report indicating the channel coherence time and/or frequency correlation information for difference subbands.

As shown at 720, the transmitter may receive feedback from the receiver including a compressed indication of precoder. In other embodiments not depicted in FIG. 7, such as those in which the transmitter requests an uncompressed indication of the precoder, the indication of the precoder may be uncompressed, and may indicate the precoder at a highest possible resolution.

At 730, the transmitter may employ a decompressor (or decoder) model to decompress the compressed indication of the precoder. The decompressor/decoder model may be an AI/ML model that is trained via online training/retraining methods, described substantially herein.

At 740, the transmitter transmits data to the receiver. The transmitted data may be precoded according to the precoding parameters fed-back by the receiver.

In some embodiments, as shown at 750, the transmitter may receive a report from the receiver indicating a key performance indicator (KPI). The KPI may include, for example, one or more of a bit error rate (BER), a signal-to-noise ratio (SNR), latency metric, or data rate. The report may include, for example, an indication that the KPI is below a threshold (e.g., a preconfigured threshold) for a given time frame or time frames (e.g., an average value of the KPI over a number of time frames is below a preconfigured threshold). In some embodiments, as shown at 760, the transmitter may, for example, initiate retraining of the precoder compression model. The transmitter may initiate the retraining based on a determination that one or more transmission requirements or parameters have not been met. The determination that transmission requirements or parameters have not been met may be made based on the report or KPI received from the receiver. Upon initiating retraining, the transmitter and/or receiver may perform steps for online training/retraining in accordance with one or more embodiments provided herein.

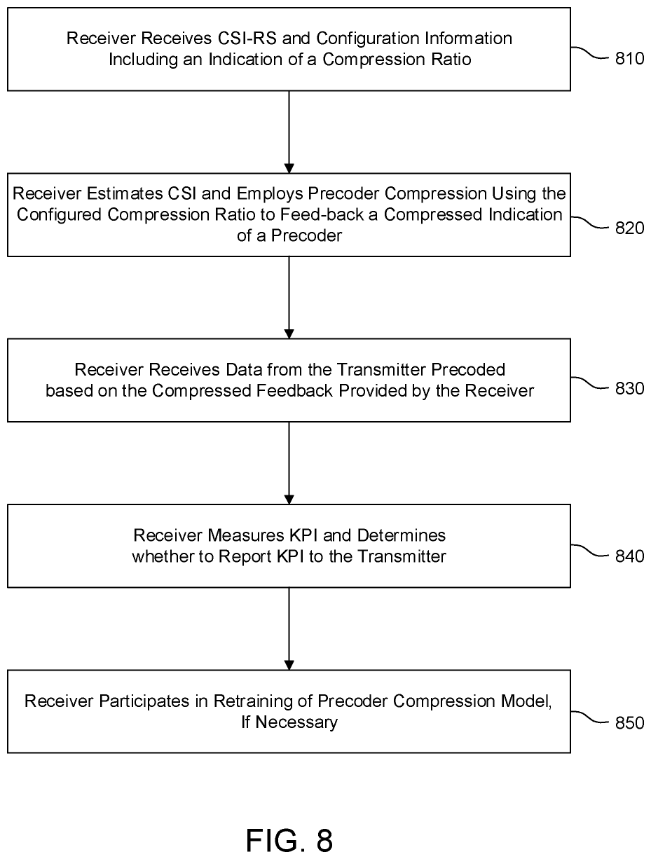

FIG. 8 is a flowchart illustrating steps for real-time data driven precoder compression as may be performed by a receiver. As shown at 810, the receive receives CSI-RS and configuration information indicating a compression ratio at which to compress the receiver's indication of the precoder. At 820, the receiver estimates CSI based on the received CSI-RS and determines precoder parameters for the channel. The receiver may utilize a precoder compression model (e.g., using an autoencoder or transfer-learning-based model) and feedback an indication of the precoding parameters that is compressed using the configured compression ratio. In some embodiments, the receiver may also send an indication of a suggested compression ratio. For example, the receiver may adaptively indicate a higher compression ratio to be used to reduce overhead, or a lower compression ratio to improve performance (and e.g., reduce decompression error) of subsequent transmissions. An indication for adaptive compression ratio provided by the receiver may be based on look-up tables (e.g., as shown in FIG. 5) or simple up/down commands.

To further reduce the feedback overhead, the receiver may perform one or more of the following steps/procedures. The receiver may leverage CSI correlation over time (channel coherence), for example, by reporting the compressed precoder only after a percentage of the channel's coherence time has elapsed. As the coherence time may differ between different subbands, the channel conditions in different subbands may vary over time depending on the environmental changes. The receiver may transmit an indication of the precoder for each subband based on the coherence time of each subband. The receiver may also leverage the correlation coefficient across subbands to obtain a low-overhead compressed precoder matrix. In embodiments not depicted in FIG. 8, the receiver may report the coherence time of each subband as well as subband frequency correlation information. The receiver may receive an uplink grant based on the coherence time to indicate a compressed precoder matrix individually for each subband.

In some embodiments, as shown at 830, the receiver may receive precoded symbols from the transmitter (i.e., symbols precoded based on the receiver's compressed indication of the precoder). At 840, the receive may determine a key performance indicator (KPI) that reflects the performance (e.g. SNR/BER) of the precoder. The receiver may determine, based on the KIP, for example, whether to report the KPI to the transmitter. The receiver may send a request to the transmitter for CSI-RS transmissions to determine the precoder and may feedback an indication of the determined precoder without compression (e.g., dispensing with the autoencoder). The receiver may also, or alternatively, send a message to the transmitter indicating that the transmitter should proceed with data transmission without employing a compression-decompression model (e.g., without using an autoencoder).

The receiver may receive the data from the transmitter. The receiver may measure the performance (e.g. BER/SNR) based on the received data. If the performance metrics are insufficient (i.e., the performance metrics do not meet a threshold value), the receiver may confirm that the channel conditions are poor and the receiver may send an indication to the transmitter to switch to the autoencoder model based data transmission. If the performance metrics are sufficient, the receiver may confirm that the autoencoder model requires recalibration. The receiver may then indicate to the transmitter that autoencoder model parameters are in error and request retraining of the autoencoder model.

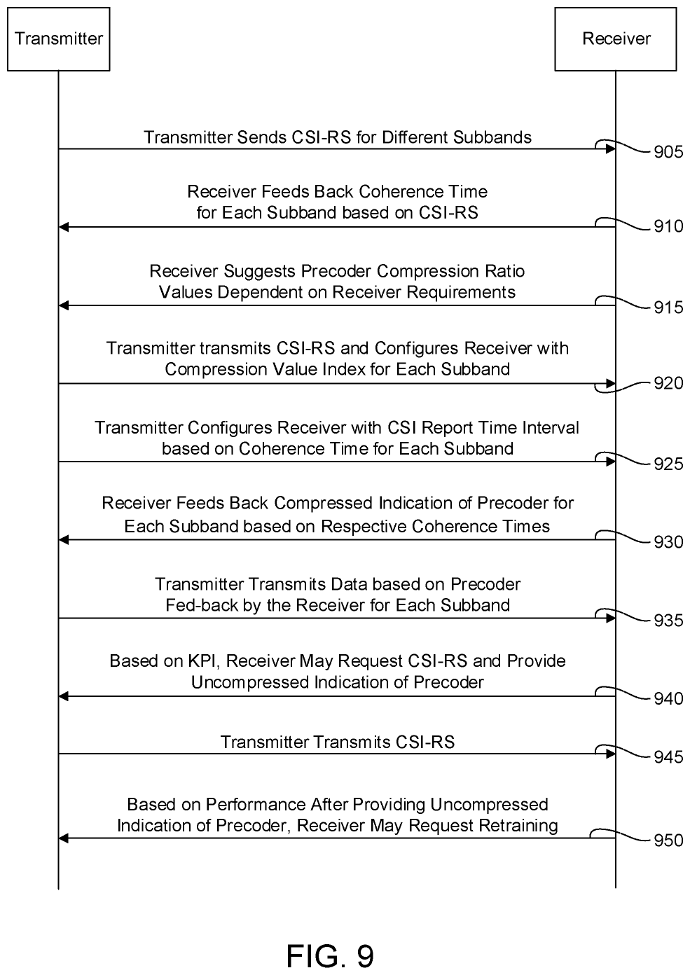

FIG. 9 is a schematic illustrating an example of the signaling between a transmitter and a receiver performing real-time link adaptation. As shown in FIG. 9, at 905, the transmitter may transmit first CSI-RS(s) in different subbands. At 910, the receiver receives the CSI-RS from the transmitter and feeds back coherence time values for each subband. In some embodiments as shown in FIG. 9 at 915, the receiver may suggest precoder compression ratio values, which may depend upon receiver requirements, capabilities, or limitations. The transmitter, at 920, transmits second CSI-RS(s) and configures the receiver with a compression value index for each subband. The compression value index may correspond to a compression ratio configured for each subband. At 925, the transmitter configures the receiver with a CSI report time interval, which may be based on the coherence time for each subband. For instance, the CSI report time interval may stipulate that the receiver send the CSI report for each subband before a percentage of the coherence time elapses.

As shown at 930, the receiver may send a CSI report to the transmitter (e.g., including a compressed indication of the precoder for each subband). The timing of the CSI report may be based on the CSI report time interval provided by the transmitter. At 935, the transmitter may transmit data using a precoder as determined from the receiver's compressed indication of the precoder. In some embodiments, as shown at 940, the receiver measures a KPI (e.g., a BER) and may request that the transmitter send third CSI-RS. After receiving the third CSI-RS, the receiver may again determine the precoder and provide an uncompressed indication of the precoder to the transmitter. The transmitter may, at 945, transmit fourth CSI-RS to enable the receiver to measure the performance of the MIMO system following the receiver's uncompressed indication of the precoder. If, at 950, the performance reaches a threshold value, the receiver may request retraining of the precoder compression model.

Although the solutions described herein consider New Radio (NR), or Long-Term Evolution (LTE), and LTE-Advanced (LTE-A) standards explicitly, it is understood that the solutions described herein are not restricted to systems that operate in accordance with these standards, and the solutions proposed herein may be applicable to other wireless systems as well.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a receiver in a multiple-input multiple-output (MIMO) system, the method comprising:
receiving, from a transmitter, first channel state information (CSI) reference signals (CSI-RSs) using a plurality of subbands;
transmitting, to the transmitter, a report indicating coherence time information associated respectively with the plurality of subbands, wherein the coherence time information associated respectively with the plurality of subbands is determined based on CSI determined from the received first CSI-RSs;
receiving, from the transmitter, configuration information indicating at least one compression ratio associated respectively with at least one of the plurality of subbands;
receiving, from the transmitter, at least one second CSI-RS using the at least one of the plurality of subbands; and
transmitting feedback to the transmitter, the feedback including compressed information indicating, for the at least one of the plurality of subbands, suggested precoding parameters determined based on the received at least one second CSI-RS, wherein the feedback is transmitted within a coherence time associated with the at least one of the plurality of subbands, and wherein the compressed information is compressed based on one of the at least one compression ratio associated respectively with the at least one of the plurality of subbands.

2. The method of claim 1 comprising receiving, from the transmitter, using the at least one of the plurality of subbands, data including symbols precoded based on the feedback including compressed information indicating suggested precoding parameters;
determining the received data does not meet a required quality threshold;
transmitting a request to the transmitter to transmit third CSI-RS including non-precoded symbols;
receiving third CSI-RSs including non-precoded symbols;
determining the third CSI-RSs including the non-precoded symbols do not meet a required quality threshold;
transmitting a message to the transmitter including a request to retrain a precoder compression model.

3. The method of claim 1 comprising transmitting, to the transmitter, a message indicating one or more suggested compression ratios associated with at least one of the plurality of subbands, wherein the received configuration information indicating the at least one compression ratio includes the indicated one or more suggested compression ratios associated with the at least one of the plurality of subbands.

4. The method of claim 1, comprising receiving, from the transmitter, configuration information indicating a CSI report time interval, wherein, based on the indicated CSI report time interval, the feedback is transmitted within a window equal to a percentage of the coherence time associated with the at least one of the plurality of subbands.

5. The method of claim 1, wherein the coherence time associated with a first one of the plurality of subbands is different from a coherence time associated with a second one of the plurality of subbands, and wherein the first one of the plurality of subbands and the second one of the plurality of subbands experience different channel conditions.

6. The method of claim 2, wherein the at least one compression ratio is associated respectively with at least one bit error rate (BER), wherein whether the received data does not meet a required quality threshold is determined based on the at least one BER associated with the at least one of the plurality of subbands.

7. A receiver configurated to operate in a multiple-input multiple-output (MIMO) system, the receiver comprising:
a processor;
a transceiver; and
at least two antennas;
the processor, the transceiver, and the at least two antennas configured to receive, from a transmitter, first channel state information (CSI) reference signals (CSI-RSs) using a plurality of subbands;
the processor, the transceiver, and the at least two antennas configured to transmit, to the transmitter, a report indicating coherence time information associated respectively with the plurality of subbands, wherein the coherence time information associated respectively with the plurality of subbands is determined based on CSI determined from the received first CSI-RSs;
the processor, the transceiver, and the at least two antennas configured to receive, from the transmitter, configuration information indicating at least one compression ratio associated respectively with at least one of the plurality of subbands;
the processor, the transceiver, and the at least two antennas configured to receive, from the transmitter, at least one second CSI-RS using the at least one of the plurality of subbands; and
the processor, the transceiver, and the at least two antennas configured to transmit feedback to the transmitter, the feedback including compressed information indicating, for the at least one of the plurality of subbands, suggested precoding parameters determined based on the received at least one second CSI-RS, wherein the feedback is transmitted within a coherence time associated with the at least one of the plurality of subbands, and wherein the compressed information is compressed based on one of the at least one compression ratio associated respectively with the at least one of the plurality of subbands.

8. The receiver of claim 7, the processor, the transceiver, and the at least two antennas configured to receive, from the transmitter, using the at least one of the plurality of subbands, data including symbols precoded based on the feedback including compressed information indicating suggested precoding parameters;
the processor configured to determine the received data does not meet a required quality threshold;
the processor, the transceiver, and the at least two antennas configured to transmit a request to the transmitter to transmit third CSI-RS including non-precoded symbols;
the processor, the transceiver, and the at least two antennas configured to receive third CSI-RSs including non-precoded symbols;
the processor configured to determine the third CSI-RSs including the non-precoded symbols do not meet a required quality threshold; and
the processor, the transceiver, and the at least two antennas configured to transmit a message to the transmitter including a request to retrain a precoder compression model.

9. The receiver of claim 7, the processor, the transceiver, and the at least two antennas configured to transmit, to the transmitter, a message indicating one or more suggested compression ratios associated with at least one of the plurality of subbands, wherein the received configuration information indicating the at least one compression ratio includes the indicated one or more suggested compression ratios associated with the at least one of the plurality of subbands.

10. The receiver of claim 7, the processor, the transceiver, and the at least two antennas configured to receive, from the transmitter, configuration information indicating a CSI report time interval, wherein, based on the indicated CSI report time interval, the feedback is transmitted within a window equal to a percentage of the coherence time associated with the at least one of the plurality of subbands.

11. The receiver of claim 7, wherein the coherence time associated with a first one of the plurality of subbands is different from a coherence time associated with a second one of the plurality of subbands, and wherein the first one of the plurality of subbands and the second one of the plurality of subbands experience different channel conditions.

12. The receiver of claim 8, wherein the at least one compression ratio is associated respectively with at least one bit error rate (BER), wherein whether the received data does not meet a required quality threshold is determined based on the at least one BER associated with the at least one of the plurality of subbands.

13-17. (canceled)

18. The method of claim 1, wherein the information indicating at least one compression ratio comprises at least one value that corresponds to the at least one compression ratio.

19. The method of claim 1, wherein the at least one value is an index that is associated with one of a plurality of compression ratios configured at the receiver.

20. The method of claim 1, wherein the receiver is a wireless transmit/receive unit (WTRU).

21. The method of claim 1, wherein the transmitter is one of a base station or a transmit/receive point (TRP).

22. The receiver of claim 7, wherein the information indicating at least one compression ratio comprises at least one value that corresponds to the at least one compression ratio.

23. The receiver of claim 7, wherein the at least one value is an index that is associated with one of a plurality of compression ratios configured at the receiver.

24. The receiver of claim 7, wherein the receiver is a wireless transmit/receive unit (WTRU).

25. The receiver of claim 7, wherein the transmitter is one of a base station or a transmit/receive point (TRP).
